(19) United States
(12) Patent Application Publication
(10) Pub. No.: US 2019/0031809 A1
(43) Pub. Date: Jan. 31, 2019

(54) POLYMERS WITH ULTRA-LOW PHOTOELASTIC BIREFRINGENCE CONSTANTS

(71) Applicants: Rohm and Haas Electronic Materials LLC, Marlborough, MA (US); Dow Global Technologies LLC, Midland, MI (US)

(72) Inventors: Praveen Agarwal, Lake Jackson, TX (US); Shih-Wei Chang, Natick, MA (US); Kathleen M. O'Connell, Cumberland, RI (US); Roy R. Raghunath, Midland, MI (US); Weijun Zhou, Sugar Land, TX (US)

(21) Appl. No.: 15/534,013

(22) PCT Filed: Dec. 7, 2015
(86) PCT No.: PCT/US15/64208

§ 371 Date: Jun. 8, 2017

Related U.S. Application Data
(60) Provisional application No. 62/093,574, filed on Dec. 18, 2014.

(51) Int. Cl. C08F 293/00; C08F 226/06; C08F 220/14; C08F 220/18

(52) U.S. Cl. CPC C08F 293/00; C08F 226/06; C08F 220/14; C08F 2500/03; C08F 2220/1833; C08F 2500/01; C08F 2800/20; C08F 220/18

(57) ABSTRACT

A polymer comprising: (a) polymerized units of 2-vinylpyridine; and (b) polymerized units of methyl methacrylate; a compound of formula (I)

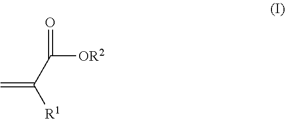

wherein R¹ is hydrogen or methyl and R² is a C₆-C₂₀ aliphatic polycyclic substituent; or a combination thereof.

### FIELD OF THE INVENTION

The present invention relates to a polymer having an extremely low photoelastic constant

### BACKGROUND OF THE INVENTION

Polymeric materials are widely used in various optical applications like lenses, optical films, compact disks and display devices. However, polymers tend to exhibit photoelastic birefringence under the application of stress, which can be a serious drawback for the utilization of polymers for many optical applications. Most polymers have a photoelastic constant (Cp) with a magnitude (absolute value) of at least 4 Brewsters (Br, 1 Br=1×10⁻¹² Pa⁻¹). Hence, polymers exhibiting low photoelastic birefringence are needed to overcome this limitation. Low-birefringence terpolymers of methyl methacrylate, benzyl methacrylate and 2,2,2-trifluoroethyl methacrylate were reported in Tagaya et al., Macromolecules, 2006, vol. 39, pp. 3019-23. However, this reference does not disclose the polymer compositions described herein.

### SUMMARY OF THE INVENTION

The present invention provides a polymer comprising: (a) polymerized units of 2-vinylpyridine; and (b) polymerized units of: (i) methyl methacrylate, (ii) a compound of formula (I)

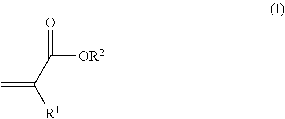

wherein R¹ is hydrogen or methyl and R² is a C6-C20 aliphatic polycyclic substituent; or (iii) a combination thereof.

### DETAILED DESCRIPTION OF THE INVENTION

Percentages are weight percentages (wt %) and temperatures are in ° C., unless specified otherwise. Operations were performed at room temperature (20-25° C.), unless specified otherwise. Boiling points are measured at atmospheric pressure (ca. 101 kPa).

The photo-elastic effect induced birefringence is determined by the photo-elastic constant of the material (Cp) and the amount of stress applied to the material (σ). The photo-elastic constant is determined by calculating the ratio of stress-induced birefringence and the magnitude of the applied stress onto the glassy material under the condition that the applied stress only induces a small degree of elastic deformation in the material. Photo-elastic birefringence of a material is different from intrinsic birefringence (Δn₀) of that material Intrinsic birefringence refers to the amount of birefringence a material exhibits when it is fully oriented in one direction, for example, by uniaxially stretching the material in one direction. Materials of positive intrinsic birefringence have a refractive index in the x-direction (nₓ), along which the material is fully oriented, larger than the refractive indices n_{y} and n_{z} in the other two directions, y and z, where x, y, z represent three distinct directions that are mutually orthogonal to each other. Conversely, materials of negative intrinsic birefringence have a refractive index in the x-direction, along which the material is fully oriented, smaller than the refractive indices in the other two directions, y and z. Materials of positive intrinsic birefringence type always tend to be of the positive photo-elastic type, whereas materials of negative intrinsic birefringence may be either of the negative photo-elasticity type or the positive photo-elasticity type.

The photo-elastic constant is an intrinsic property of each material and may have a positive or negative value. Thus, materials are divided into two groups: a group having a positive photo-elastic constant and the other group having a negative photo-elastic constant. Materials with a positive photo-elastic constant tend to exhibit positive birefringence (i.e., nx>ny) when the material in subject to small degree of uni-axial tensile stress along the x-direction. Conversely, materials with a negative photo-elastic constant will exhibit negative birefringence (i.e., nx<ny) when the material is subject to a small degree of uni-axial tensile stress along the x-direction.

Retardation is a measure of birefringence in a sheet of material. It is defined as the product of An and the thickness of the sheet, where Δn is the absolute value of the difference between nₓ and n_{y}.

Preferably, the amount of polymerized units of methyl methacrylate (MMA) in the polymer, based on the total weight of the polymer, is from 20 to 90 wt %; preferably at least 25 wt %, preferably at least 30 wt %, preferably at least 35 wt %, preferably at least 40 wt %, preferably at least 45 wt %, preferably at least 50 wt %, preferably at least 55 wt %; preferably no more than 85 wt %, preferably no more than 80 wt %, preferably no more than 75 wt %. Preferably, the amount of polymerized units of 2-vinylpyridine (2-VP) in the polymer, based on the total weight of the polymer, is from 10 to 80 wt %; preferably at least 15 wt %, preferably at least 20 wt %, preferably at least 25 wt %; preferably no more than 75 wt %, preferably no more than 70 wt %, preferably no more than 65 wt %, preferably no more than 60 wt %, preferably no more than 55 wt %, preferably no more than 50 wt %, preferably no more than 45 wt % Preferably, the amount of polymerized units of the compound of formula (I) in polymer, based on the total weight of the polymer, is from 15 to 90 wt %; preferably at least 20 wt %, preferably at least 25 wt %, preferably at least 30 wt %, preferably at least 35 wt %, preferably at least 40 wt %, preferably at least 45 wt %; preferably no more than 80 wt %, preferably no more than 70 wt %, preferably no more than 65 wt %, preferably no more than 60 wt %, preferably no more than 55 wt %, preferably no more than 50 wt %, preferably no more than 45 wt %.

In one preferred embodiment of the invention, the polymer comprises polymerized units of 2-vinylpyridine and MMA. Preferably, the polymer comprises less than 30 wt % polymerized units of the compound of formula (I), preferably less than 20 wt %, preferably less than 15 wt %, preferably less than 10 wt %, preferably less than 5 wt %, preferably less than 2 wt %.

In another preferred embodiment of the invention, the polymer comprises polymerized units of 2-vinylpyridine and the compound of formula (I). Preferably, the polymer comprises less than 30 wt % polymerized units of methyl methacrylate, preferably less than 20 wt %, preferably less than 15 wt %, preferably less than 10 wt %, preferably less than 5 wt %, preferably less than 2 wt %.

Preferably, the copolymer is prepared by free radical polymerization in solution. Preferably, the weight average molecular weight (Mw) of copolymers is larger than 50,000 g/mole, preferably larger than 75,000 g/mole, preferably greater than 100,000 g/mole, all based on polystyrene equivalent molecular weight. Copolymers with Mw less than 50,000 g/mole are too brittle to be used for many practical applications.

Preferably, R² is a C₇-C₁₅ aliphatic polycyclic substituent, preferably R² is a C₈-C₁₂ aliphatic polycyclic substituent. Preferably, R² is a bridged polycyclic substituent; preferably a bicyclic, tricyclic or tetracyclic substituent. Preferred structures for R² include, e.g., adamantanes, bicyclo[2,2,1]alkanes, bicyclo[2,2,2]alkcanes, bicyclo[2,1,1]alkanes; these structures may be substituted with alkyl, alkoxy or hydroxy groups; preferably methyl and/or hydroxy groups. Adamantanes and bicyclo[2,2,1]alkcanes are especially preferred. Preferably, R¹ is methyl. Preferably, the compound of formula (1) is 1-hydroxy-3-adamantyl methacrylate (HAMA).

Optical materials with low photo-elastic birefringence described herein have utility for a wide variety of optical molding applications and film extrusion applications, for example, optical lenses for camera and mobile phones, fiber and discs, collimation and imaging optics for printers and copiers, light sensor components, optical films for flat panel display, etc. If desired, one or more types of additives such as an antioxidant, an ultraviolet (UV) light stabilizer, a plasticizer, a release agent, an anti-static agent, or any other conventional additive can be incorporated into the copolymer composition for desired processing and property enhancements.

The polymeric material may also be used as a coating layer for property modification of optical components such as molded articles, optical films or sheets, glass substrates, optical screens, display panels, etc. Coating of the polymeric material of this invention onto a substrate may be carried out by suitable coating processes well known in the art For example, the polymeric material may be coated onto a glass sheet by dip coating, spin coating or slot die coating. A slot die coating process is more preferable with its relatively easy control of coating area, coating thickness and uniformity. The preferable range of the thickness of the polymeric material layer is no more than 1 mm, preferably no more than 500 μm, preferably no more than 200 μm, preferably no more than 100 μm, preferably no more than 50 μm, preferably no more than 25 μm. Preferably the thickness of the polymeric material is at least 1 μm, preferably at least 5 μm, preferably at least 10 μm.

If the polymer is coated on a glass substrate, the preferred range of the thickness of the glass sheet is from 0.1 mm to 0.7 mm, preferably from 0.2 mm to 0.5 mm. When the thickness of the glass substrate is greater than 0.7 mm, the effect of optical coating may not be strong enough and this will also increase the thickness of the device. When the glass substrate is less than 0.1 mm, its physical rigidity becomes problematic for device fabrication.

### EXAMPLES

Polymers were compression molded in the temperature range of 150° C. to 200° C. to obtain a free standing film. Film thickness was in the range of 100-1000 microns. Polymer films were cut into approximately 1″×3″ (2.54×7.62 cm) size and mounted on a uniaxial tensile stretching stage attached to Exicor 150 AT birefringence measurement systems (Hinds Instruments). Optical retardation of the films was measured at a wavelength of 546 nanometers (nm) as a function of the applied force. Force was controlled manually and measured by OMEGA DFG41-RS force transducer connected to one of the sample mounting grips. Applied force was in the range of 0-25 Newtons. Photoelasticity constant or stress optic coefficient, Cₚ, was calculated from the slope of the stress vs. birefringence plot.

Glass transition temperature (Tg) of the polymers was measured by the differential scanning calorimetry (DSC) using a heating/cooling rate of 10° C./min and the values are reported from the second heating cycle. Characterization was conducted on Q1000 DSC Instruments (TA Instruments, Inc.). General principles of DSC measurements and applications of DSC to studying Tg are described in standard texts (for example, E. A. Turi, ed., Thermal Characterization of Polymeric Materials, Academic Press, 1981).

Cp and glass transition temperature of the 2-VP and MMA copolymers for four different compositions are shown in Table 1. It can be seen that polymers having a certain monomer composition provide an ultralow photoelastic coefficient

Cp and Tg values of 2-VP and HAMA copolymer with various ratios are shown in Table 2. It can be seen that polymers having a certain monomer composition provide an ultralow photoelastic coefficient

TABLE 1
Molecular weight, polydispersity, Cp and Tg
values for 2-VP and MMA copolymers

| | Mw × 10⁻³ | | | |
|---|---|---|---|---|
| 2-VP:MMA | [gm/mole] | PDI | Cp [Br] | Tg [° C.] |
| 100:0 | 200 | nm | 11.1 | 104 |
| 0:100 | nm | nm | −4.3 | 116 |
| 70:30 | 137.6 | 1.9 | 2.9 | 104 |
| 45:55 | 161 | 2.28 | 0.8 | 105 |
| 40:60 | 143.7 | 1.8 | 0.5 | 107 |
| 20:80 | 259 | 1.96 | −1.4 | 111 |

nm = not measured

TABLE 2
Molecular weight, polydispersity, Cp and Tg
values for the 2-VP and HAMA copolymers

| | Mw × 10⁻³ | | | |
|---|---|---|---|---|
| 2-VP:HAMA | [gm/mole] | PDI | Cp [Br] | Tg [° C.] |
| 95:5 | 216.8 | 1.95 | 10.1 | 108 |
| 90:10 | 191.9 | 1.93 | 7.8 | 112 |
| 80:20 | 197.6 | 1.83 | 6.5 | 115 |
| 70:30 | 223.9 | 2.03 | 5.0 | 119 |
| 60:40 | 193 | 1.89 | 2.2 | 142 |
| 50:50 | 236.5 | 2.02 | 0.6 | 136 |
| 40:60 | 213 | 2.6 | nm¹ | 171 |

¹Cp not measured due to high brittleness.

1. A polymer comprising: (a) polymerized units of 2-vinylpyridine; and (b) polymerized units of: (i) methyl methacrylate, (ii) a compound of formula (I) 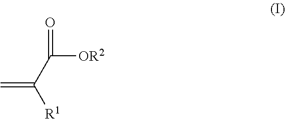
wherein R¹ is hydrogen or methyl and R² is a C₆-C₂₀ aliphatic polycyclic substituent; or (iii) a combination thereof.

2. The polymer of claim 1 in which R² is a bridged polycyclic substituent.

3. The polymer of claim 2 in which R² is a C₇-C₁₅ bridged polycyclic substituent.

4. The polymer of claim 3 in which R¹ is methyl.

5. The polymer of claim 3 comprising polymerized units of from 10 to 80 wt % of 2-vinylpyridine and from 20 to 90 wt % of methyl methacrylate.

6. The polymer of claim 5 in which R¹ is methyl.

7. The polymer of claim 3 comprising polymerized units of from 45 to 85 wt % of 2-vinylpyridine and from 15 to 55wt % of the compound of formula (I).

8. The polymer of claim 4 in which in which R¹ is methyl.
